(19) United States
(12) Patent Application Publication
(10) Pub. No.: US 2005/0202377 A1
(43) Pub. Date: Sep. 15, 2005

(54) Remote controlled language learning system

(76) Inventor: Wonkoo Kim, Santa Clara, CA (US)

Correspondence Address: Sidley Austin Brown & Wood LLP, Suite 5000, 555 California Street, San Francisco, CA, 94104, US

(21) Appl. No.: 10/797,831

(22) Filed: Mar. 10, 2004

(51) Int. Cl. G09B 19/00; G09B 19/06; G09B 19/08

(52) U.S. Cl. 434/156; 434/157

(57) ABSTRACT

An interactive multimedia language system allows a user to view and repeat foreign language words and phrases at will with a remote control that includes a microphone. The user can compare the sound of his pronunciation captured by the microphone in the remote and amplified by the system to a reference pronunciation provided by the system, and can repeat and alter his pronunciation to his satisfaction.

### BACKGROUND

1. Field

The present invention relates generally to devices used in language learning, and more specifically to remote controlled multimedia devices used to teach people foreign languages.

2. Related Art

Over the years, numerous systems have been developed to help people learn foreign languages. Cassette tapes, compact discs, and CD ROM's are a common type of self-study. However, these formats have limited interactivity, content accessibility, and visual graphics. Additionally, general purpose or “off the shelf” multimedia players lack many features needed for efficient language study.

Also, new languages are most easily learned by young children, and general-purpose multimedia players are ill-suited for use by children for many reasons, most notably because the ergonomics of such devices are tailored for adult users.

### SUMMARY

An interactive multimedia language system allows a user to view and repeat foreign language words and phrases at will with a remote control that includes a microphone. The user can compare the sound of his pronunciation captured by the microphone in the remote and amplified by the system to a reference pronunciation provided by the system, and can repeat and alter his pronunciation to his satisfaction.

Other aspects of the present invention are found in the remote control uniquely tailored to the language learning environment. One aspect is that the remote can be held in a wide variety of positions while activating the keys and/or using the microphone, yet still transmit a strong signal to the system. Another aspect is an ergonomic design tailored to young children, encouraging them to learn a language at a time when they are especially adept.

### BRIEF DESCRIPTION OF THE FIGURES

FIG. 1A is a block diagram of system 100, according to an embodiment of the present invention.

FIG. 1B is a block diagram of control unit 150 in FIG. 1B.

FIG. 2A is a block diagram of remote 108.

FIG. 2B is a block diagram of module 142.

FIG. 3 is a plan view of remote control 108.

FIG. 4A is a flow chart of the operation of system 100, an embodiment of the present invention.

FIG. 4B is a depiction of an interface screen of system 100.

FIG. 5A is a top view of remote 108 illustrating the infrared beam spread.

FIG. 5B is a plan view of remote control 108 illustrating the infrared beam spread.

FIG. 5C is a side view of remote control 108 illustrating the infrared beam spread.

Like numerals are used throughout the figures to describe like components.

### DETAILED DESCRIPTION

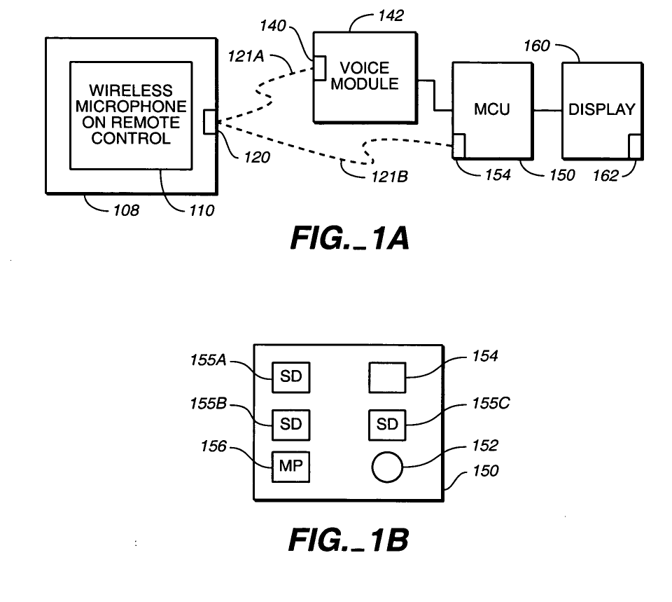

FIGS. 1A and 1B illustrate system 100, an embodiment of the present invention. This embodiment of the present invention is a remote controlled language learning system. While this system will be described in detail, it should be understood that the present invention should not be limited to the embodiment described, but only by the appended claims.

Remote control 108 is used to control the various functions of system 100, including reproducing a users' voice. To that end, remote control 108 comprises a microphone 110 and infrared or other type transducers 120 that transmit signals 121 (audio signals 121A, command signals 121B) to main control unit (“MCU”) 150. Signals 121 may be transmitted to both MCU 150 and to voice module 142. Voice module 142 may be a discrete module that plugs into MCU 150 or may be integrated into MCU 150. As a discrete module, voice module (“VM”) 142 may be an add-on to a base DVD or other player/recorder, and serves to increase the functionality of the player/recorder. Voice module 142 comprises receiver (transducer) 140, and MCU 150 comprises receiver (transducer) 154, both for receiving signals from remote control 108. The user's voice, contained in audio signal 121A, is received by receiver 140 of voice module 140, whereas the remainder of the commands from remote control 108, contained in command signals 121b, are received by receiver 154 of MCU 150. If VM 142 is integrated into MCU 150, only one of receivers 140 or 154 is necessary, and that receiver will receive both audio and command signals.

MCU 150 also comprises a speaker 152 for reproducing various audio signals, including a signal representing the voice of a user of system 100 captured/transmitted through microphone 110 and remote 108.

MCU 150, seen in detail in FIG. 1B, also comprises microprocessor 156, and one or more storage devices 155A, B, C, . . . used to store content to be presented to the user via display 160, and to store the user's voice and other selected information. The storage devices include any combination of optical drives such as a DVD player/recorder or a CD player/recorder, a hard disk, and solid state memory such as RAM or ROM, including the flash type. Display 160 may also comprise a speaker 162 for reproducing the audio content of system 100. Although VM 142, MCU 150, and display 162 are represented as individual units, in embodiment they may be integrated into a single unit.

The signals containing voice information (“voice signal”) are transmitted to the voice module 142, and may be reproduced by either a speaker 152 within control unit 150 or speaker 162 of display 160.

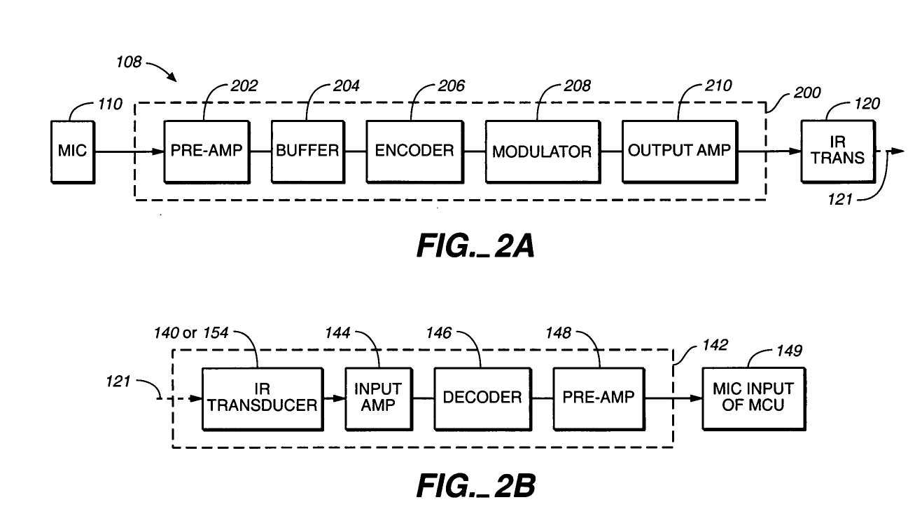

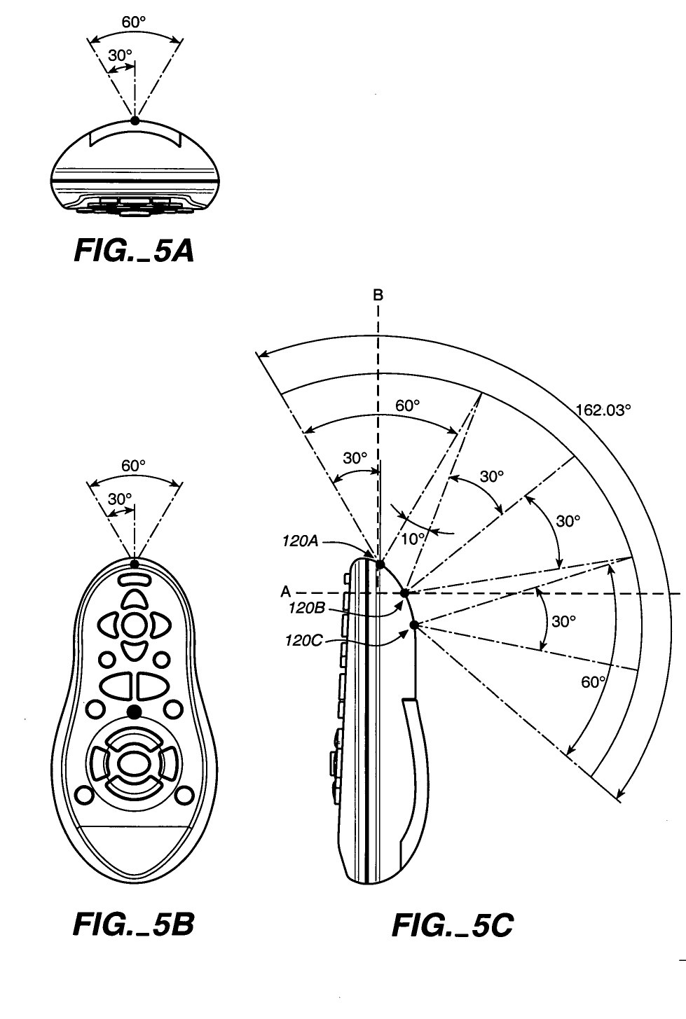

FIG. 2A is a block diagram of remote 108. Transmitter 200 receives its input from microphone 110, which may be processed by some intermediate circuitry. The transmitter then outputs the signal to infrared transducers 120, which will be discussed in more detail with regard to FIGS. 5A-C. The transmitter 200 comprises a pre-amplifier 202, an audio processing/buffering chip 204, a frequency modulation (FM) encoder 206, a carrier frequency modulator 208, and an infrared output amplifier, all of which are well known in the art.

FIG. 2 is a block diagram of voice module 142, which comprises infrared signal amplifier 144, FM decoder 146, and pre-amplifier 148. The receiver input arrives from infrared sensor 140 or 154. As mentioned previously, receiver module 140 may be integrated with MCU 150, and in such a case, only one infrared sensor may be utilized. If, however, voice module 142 is a discrete module, the module may be plugged into the microphone input of the MCU 150, in order to transmit the audio content to the unit.

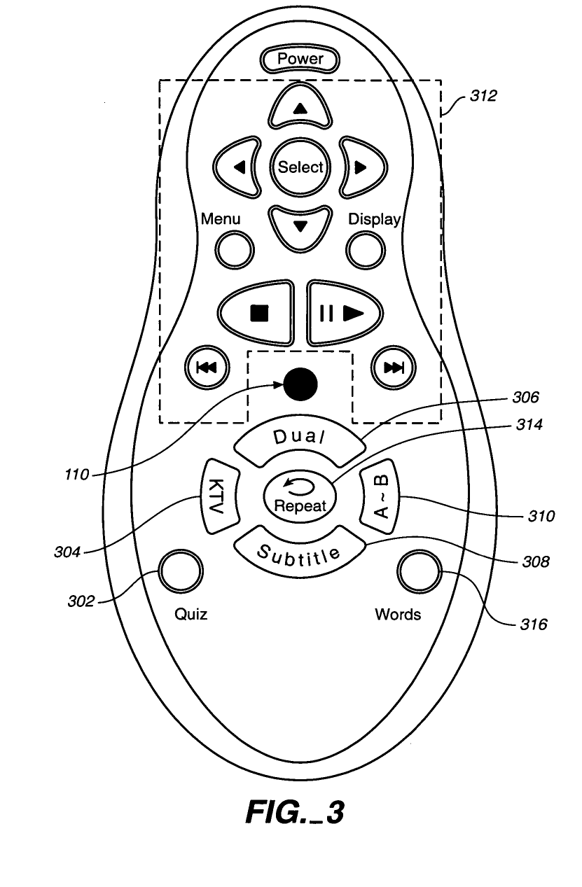

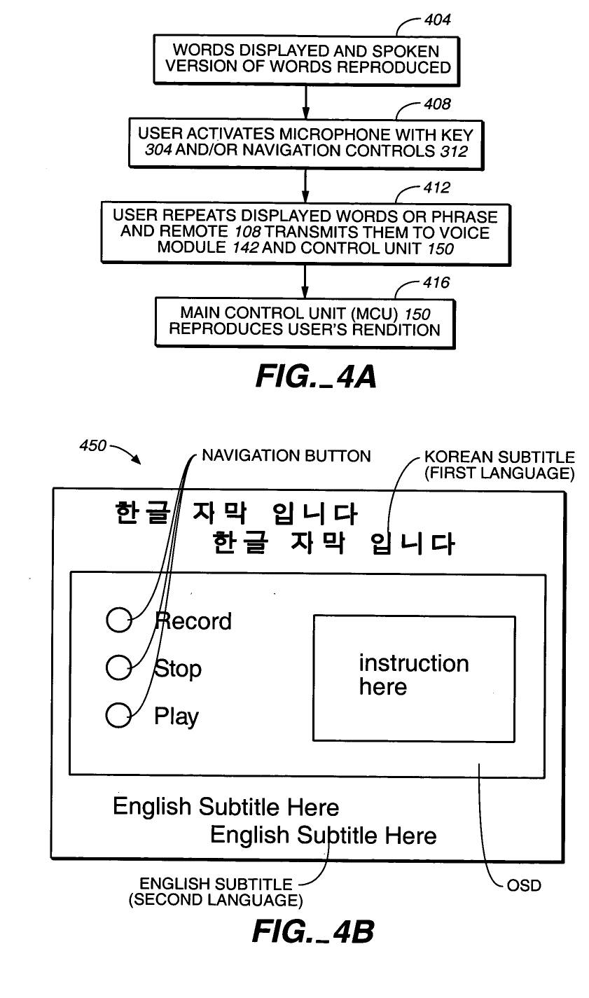

In FIG. 3 the remote 108 can be seen, and the aspects of remote 108 relating to the voice and language functionality of system 100 will now be described, in tandem with the flowchart of FIG. 4A and the exemplary screen 450 seen in FIG. 4B.

Remote control 108 comprises many controls used in the navigation and content selection similar to the well known controls in commercially available cassette and disc (optical media) based players and recorders. These include the navigation controls 312 used to select from displayed content links or functions displayed in screen 450. Remote 108 also comprises microphone 110, quiz button 302, microphone activation (“KTV”) button 304, dual button 306, subtitle button 308, A˜B button 310, repeat button 314, and words button 316.

Many different language learning scenarios with different steps are conceivable with system 100, and within the scope of the present invention. One such scenario or embodiment is seen in FIG. 4A and will now be described. In step 404, words are displayed on a screen such as screen 450 and a reference-spoken version of the words are reproduced. Thus, a user may not only see the written words but also hear the correct pronunciation. The user can repeat these spoken words as many times as he would like with words button 316. Screen 450 illustrates a scenario where a native Korean speaker is endeavoring to learn English, or vice-versa. Generally speaking, both a first and second language can be displayed on the screen, and the user's native language could be either the first or second language. This aids the user in not only correlating the pronunciation with the written word to be learned, but also with his native language.

Next, the user activates microphone 110 with key 304 and/or navigation controls 312. Alternatively, the microphone may be voice activated. Once the microphone is activated, the user then repeats the displayed and spoken words or phrase and remote 108 transmits them to voice module 142 and control unit 150. MCU 150 then reproduces the user's rendition of the words one or more times. The number of times it is reproduced can be set in advance when setting up the system, and can be augmented or reduced by the user after he has heard his rendition the first time. In this way, the user can now compare his rendition or version to the (reference) spoken version produced by system 100. The user can choose to repeat his rendition as many times as he would like, or may choose to repeat both the reference rendition and his rendition sequentially, in order to hear the nuances of each word. In one embodiment, the repeat key will only repeat the user's rendition, and in another embodiment, it is programmed to repeat both the spoken and the user's rendition. Different activation of the repeat selection could also be accomplished by hitting the key once or twice, or by holding it down for a certain duration, for example.

When a user repeats the phrases into microphone 110 of remote 108 he may hold the remote at any variety of angles. This would present a problem if the remote 108 was designed like a standard remote control. Most standard remote controls are more or less rectangular and are designed to be pointed at the device they control. The standard remote typically has the transmitter, which includes a horizontal row of one or more infrared transducers, on the distal end of the remote such that when a button is pressed on the top side, the remote is held approximately horizontally and the transmitter is aimed directly at the device to be controlled. However, because of the unique shape of remote 108, and the placement of microphone 110 in approximately the center of the front face of the remote, the user may tend to hold the remote such that the distal end is not aimed at MCU 150. In fact, the user may tend to hold it like a more like a microphone than a typical remote control. If remote 108 had a transmitter with a row of transducers as in a typical remote, they would, in that case, be pointed directly at the ceiling. That would result in poor signal transmission to the main control unit 150.

Remote 108 is designed such that it will directly transmit signals to the main unit when held in a variety of positions, as can be seen in FIGS. 5A-5C. While other remotes may get the signal to the main unit when held in other than an approximately horizontal position, the signals must typically be reflected from one or more walls or other surfaces. However, remote control 108 is designed to transmit directly from the transducers of the remote, when held far from horizontal, to the transducers of the main unit. FIG. 5C illustrates the over 160 degree beam spread created by transducers 120A, 120B, and 120C. With respect to axis A, which can be considered the typical horizontal axis of a remote control, the beam pattern spreads 30 degrees above horizontal to over 120 degrees below horizontal. This wide range, in particular the 120 degrees below horizontal (axis A), allows the remote to transmit directly to the main unit, while a user is holding the remote upright (parallel to axis B). Thus, a user can conveniently activate the various functions of the main unit 150 via the keys of remote 108, in particular the record function, and then speak into the remote, all while holding the remote upright in front of him. This is advantageous because without such a wide beam spread, the user may have to first hold the remote in one position to command the main unit, and then change the angle of the remote to speak into the remote.

Referring again to FIG. 3, there is a quiz button 302 in the lower left corner. At certain points in a learning application, a quiz may be available for the user. When a quiz is available, it will be indicated on screen in some fashion, preferably with a small quiz indicator. The quiz will contain questions on topics germane to the information being presented. If the user clicks upon quiz button 302, he will access the quiz. This pauses the video, and displays hyperlinked full screens that pose the questions to be answered. Once the quiz is completed, a score is registered, and by pressing the quiz button again the user returns to the video, which has been bookmarked at the pause point.

Another advantage of the present invention is a child friendly interface and ergonomic design. The language learning system of the present invention is particularly useful in helping children learn foreign languages. Accordingly, one embodiment includes a remote designed for child-sized hands. The remote is designed so that even a child can hold it with one hand, activate the simple arrangement of keys with his thumb, and then speak into the remote. As seen in FIG. 3 the most frequently used keys in language learning, keys 304, 306, 308, and 310 surround the important repeat key 314, and are all easily activated with your thumb. The bottom lobe has a width of approximately 60 millimeters and easily rests in the palm of even a child's hand. The pear shaped design facilitates singled-handed usage and comfort, for all ages and sizes of people. The waist (area between the two lobes) of the pear-shaped design is approximately 67 millimeters from the bottom edge of the remote, and the thickness varies, with the maximum thickness of the bottom lobe being approximately 32 millimeters and the maximum thickness of the top lobe being about 25 millimeters. The upper lobe is much narrower than the bottom lobe and has a width of approximately 44 millimeters, and the overall length of the remote is approximately 120 millimeters. While the dimensions have been given for one exemplary child size embodiment, it should be clear that other smaller or larger embodiments are also within the scope of the invention.

1. A DVD based learning system comprising:
a first device comprising a DVD drive; and
a remote control comprising controls and a microphone,
the first device operable to display words in a first language upon a display, and to playback a pre-recorded rendition of the one or more words,
the remote control operable to receive a users spoken rendition of the one or more displayed words and transmit said spoken rendition to the first device,
the first device operable to reproduce said spoken rendition.

2. The system of claim 1 wherein the system is further operable to reproduce said spoken rendition simultaneously with said pre-recorded rendition.

3. The system of claim 1 wherein the system is further operable to reproduce said spoken rendition and said user rendition sequentially.

4. The system of claim 1 wherein the system is operable to receive and record speech from the user.

5. The system of claim 1 wherein the user can repeat her spoken and recorded rendition multiple times until satisfied with her rendition.

6. The system of claim 1 wherein the user can select additional words to practice with the remote control.

7. The system of claim 1 wherein the first device can display the words in the first language and additional languages simultaneously.

8. The system of claim 1 wherein one of the additional languages is a user's preferred language.

9. The system of claim 1 wherein the microphone is activated by one of the controls of the remote control.

10. The system of claim 9 wherein the microphone is voice activated.

11. The system of claim 1 wherein the remote control is child sized, having a pear-like shape with a distal lobe and a proximal lobe, the proximal lobe sized to fit in the palm of a child's hand, and having a width larger than the width of the distal lobe.

12. The system of claim 11 wherein the proximal lobe is about 60 millimeters wide, and wherein the remote is about 120 millimeters long.

13. The system of claim 1 wherein the remote is operable to directly transmit said spoken rendition to the first device while held in an upright position.

14. The system of claim 1 wherein the remote control includes a button that causes, with one touch, the dictionary meaning of one or more displayed words to appear on the display.

15. A method for teaching and learning a foreign language lesson, the method comprising:
displaying at least one word in a foreign language upon an electronic display with a first device;
reproducing said at least one word over a speaker;
receiving, at a remote control, a student's spoken version of the at least one displayed word;
transmitting from said remote control, to said first device, the spoken version; and
reproducing said spoken version at said first device, through said speaker.

16. The method of claim 15 further comprising recording said spoken version for playback when requested.

17. The method of claim 15 wherein reproducing said spoken version is done in real time.

18. The method of claim 15 wherein a portion of the foreign language lesson is stored on a DVD.

19. The method of claim 15, further comprising producing a spoken reference version of said at least one word when displaying said at least one word.

20. The method of claim 19 wherein said spoken reference version is that of a native speaker of the foreign language.

21. A system for teaching a student a foreign language comprising;
providing foreign language content on an optical disc at a first device;
causing words in the foreign language to appear upon a display;
providing a reference-spoken version of the displayed words;
receiving, at a microphone provided in a remote control, the students spoken version of the displayed words while the words appear on the display;
modulating said spoken version into a signal at the remote control;
transmitting the modulated signal to the first device; and
demodulating the signal at the first device and, upon receipt of a command from the student, playing back the spoken version at the first device.

22. The system of claim 21 wherein the remote control is child sized, having a pear-like shape with a distal lobe and a proximal lobe, the proximal lobe sized to fit in the palm of a child's hand, and having a width larger than the width of the distal lobe.

23. The system of claim 22 wherein the proximal lobe is about 60 millimeters wide, and wherein the remote is about 120 millimeters long.

24. The system of claim 21 wherein the student triggers the remote to receive the student's spoken words by pressing a button of the remote control.

25. The system of claim 21 wherein the students voice triggers the remote control to receive the spoken words.

26. A remote control for use with a language learning system, the remote:
having a pear like shape, with two lobes, a lobe proximal to the user, and a lobe distal to the user, the distal lobe comprising an infrared transducer, the proximal lobe larger than the distal lobe, the remote also comprising a microphone;
operable to cause the language learning system to display a group of words to be learned by an operator of the remote and the system; and
operable to cause the language learning system to sonically reproduce a reference pronunciation of the displayed words,
the microphone of the remote operable to receive the operators spoken version of the displayed words and to transmit a signal representing said spoken words to the language learning system, the system operable to amplify and reproduce said signal, thus allowing the operator to compare his spoken version to the reference version.

27. The remote control of claim 26 wherein the remote control is child-sized.

28. The remote control of claim 27 wherein the remote control has a maximum width of about 60 millimeters.

29. A remote control comprising:
a top side including a microphone and keys that control a distant device; and
an underside including a grouping of transducers that transmit control signals and sound received by the microphone to the distant device,
the group of transducers arranged so that a beam pattern formed by the group of transducers is such that the remote can be held substantially upright or substantially horizontally and transmit the control signals and sound directly to the distant device in either position.
